(19) United States
(12) Patent Application Publication
(10) Pub. No.: US 2019/0078378 A1
(43) Pub. Date: Mar. 14, 2019

(54) AUTOMATIC DOOR SEAL

(71) Applicant: Raven Products Pty Ltd, Lonsdale (AU)

(72) Inventor: Neil Andrew Raven, Lonsdale (AU)

(73) Assignee: Raven Products Pty Ltd, Lonsdale, South Australia (AU)

(21) Appl. No.: 16/128,436

(22) Filed: Sep. 11, 2018

(30) Foreign Application Priority Data
Sep. 12, 2017 (AU) 2017903697

(51) Int. Cl. E06B 7/20; E06B 7/215; E06B 1/70

(52) U.S. Cl. CPC E06B 7/20; E06B 1/70; E06B 7/215

(57) ABSTRACT

An automatic door seal assembly for a door is provided. In one aspect, the assembly includes a magnet secured to a surface of a doorway or a floor area within the doorway adjacent to an edge of the door in a closed position. The assembly further includes a door edge assembly configured to mount to an edge of the door and having a base and a sealing strip assembly with a ferromagnetic part. The sealing strip assembly is generally movable between a retracted position and an extended position relative to the base, wherein the magnet transitions the sealing strip assembly to the extended position as the door approaches the closed position to contact and seal against one or more of the surface of the doorway, the floor area within the doorway, and the magnet.

### BACKGROUND

Door bottom seals fill the gap between the bottom of a door and the floor underneath. They are generally designed to either sweep across the floor as the door moves, or engage a raised threshold plate when closed, meaning they clear the floor as the door opens.

Automatic door bottom seals seal tight against a threshold plate when the door is closed, and lift clear of the floor as the door opens. Previously, this has been achieved by the cooperation of two strip magnets, where the threshold plate comprises one of these, and the door bottom seal the other, and where these two strips align as the door reaches the closed position. However, because a threshold plate projects from the floor surface, it is possible for a person to be tripped by it. Moreover, some consider threshold plates unsightly, and would prefer not to use them.

It is against this background and the problems and difficulties associated therewith that the present disclosure has been developed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

According to a first aspect, there is provided an automatic door seal assembly for a door which is movable between open and closed positions with respect to a doorway, the automatic door seal assembly comprising at least one magnet for securing with respect to either the doorway or a floor area within the doorway, a door edge assembly for mounting with respect to an edge of the door, the door edge assembly comprising a base, at least one elastic element depending from the base, at least one sealing strip assembly comprising at least one ferromagnetic part and depending from the elastic element so as to be movable between a retracted position and an extended position relative to the base, wherein in use, the elastic element may bias the sealing strip assembly toward the retracted position and clear of the doorway or floor, and the magnet may overcome the bias of the elastic element to draw the sealing strip assembly into the extended position as the door reaches its closed position, to seal the sealing strip assembly directly against both the magnet and the floor.

The automatic door seal assembly can be used at any one of the bottom, top or side edges of the door. Where the automatic door seal assembly is used at a bottom edge of the door, it might be referred to as an automatic door bottom seal assembly.

It will be apparent then, that the automatic door seal assembly described above does not comprise a threshold plate.

In one form, the or each magnet is secured to the doorway or the floor area within the doorway in such a way as to be substantially flush therewith.

When flush mounted, the magnets do not pose a tripping hazard. This is particularly important to the physically challenged and the elderly.

In one form, in an alternative, the or each magnet is secured to the doorway or the floor area within the doorway in such a way as to project therefrom.

In either case, it is preferable that the or each magnet is positioned at or near an edge of the doorway.

In one form, the or each magnet is a rare earth magnet. Rare earth magnets are preferred for their stronger magnetic fields than other types of permanent magnets. This is turn facilitates the use of only one magnet at the hinge edge of the door, and one magnet at the latch edge of the door, as discussed above.

In one form, the sealing strip assembly directly seals against the doorway or the floor predominantly, as the door reaches its closed position.

In one form, the base comprises a channel in which the sealing strip assembly is seated, and with respect to which can move between its extended and retracted positions.

In one form, the or each elastic element comprises a spring.

In one form, the or each spring is a leaf spring.

In one form, in an alternative, the or each spring is a coil spring.

In one form, the sealing strip assembly comprises an elongate body.

In one form, the sealing strip assembly comprises an elongate sealing strip, or gasket, disposed over the body.

In one form, the or each ferromagnetic part depends from the body and is positioned behind the gasket.

In one form, the or each ferromagnetic part comprises a flat strip.

In one form, the or each ferromagnetic part is metal.

By using one rare earth magnet at each end in the threshold this steel strip may be used instead of a further magnet in the door assembly attached to the door. This is more economical than using two strip magnets.

In one form, in an alternative, the or each ferromagnetic part is a magnet.

That is to say, the door edge assembly comprises one or more magnets, which in use, will be attracted to the or each magnet secured with respect to either the doorway or the floor area within the doorway.

In one form, the door edge assembly is adapted to be mounted to a face of the door.

In one form, in an alternative, the door seal assembly is adapted to be mounted within a recess in an edge of the door, so as to be substantially concealed.

In one form, the door comprises a mortise, and the door seal assembly comprises a tenon for engagement with the mortise.

In one form, the door seal assembly comprises a door pivot pin.

In one form, in an alternative, the door seal assembly comprises a mount for receiving a door pivot pin.

According to a further aspect, there is provided a door edge assembly for use with at least one magnet secured with respect to either a doorway or a floor area within the doorway, the door edge assembly comprising a base for mounting with respect to an edge of the door, at least one elastic element depending from the base, at least one sealing strip assembly comprising at least one ferromagnetic part and depending from the elastic element so as to be movable between a retracted position and an extended position relative to the base, wherein in use, the elastic element may bias the sealing strip assembly toward the retracted position and clear of the doorway or floor, and the magnet may overcome the bias of the elastic element to draw the sealing strip assembly into the extended position as the door reaches its closed position, to seal the sealing strip assembly directly against both the magnet and the doorway or floor.

According to a further aspect, there is provided an automatic door bottom seal assembly for a door which is movable between open and closed positions with respect to a doorway, the automatic door bottom seal assembly comprising at least one magnet for securing with respect to a floor area within the doorway, a door bottom assembly for mounting with respect to a bottom edge of the door, the door bottom assembly comprising a base, at least one elastic element depending from the base, at least one sealing strip assembly comprising at least one ferromagnetic part and depending from the elastic element so as to be movable between a retracted position and an extended position relative to the base, wherein in use, the elastic element may bias the sealing strip assembly toward the retracted position and clear of the floor, and the magnet may overcome the bias of the elastic element to draw the sealing strip assembly into the extended position as the door reaches its closed position, to seal the sealing strip assembly directly against both the magnet and the floor.

According to a further aspect, there is provided a door bottom assembly for use with at least one magnet secured with respect to a floor area within the doorway, the door bottom assembly comprising a base for mounting with respect to a bottom edge of the door, at least one elastic element depending from the base, at least one sealing strip assembly comprising at least one ferromagnetic part and depending from the elastic element so as to be movable between a retracted position and an extended position relative to the base, wherein in use, the elastic element may bias the sealing strip assembly toward the retracted position and clear of the floor, and the magnet may overcome the bias of the elastic element to draw the sealing strip assembly into the extended position as the door reaches its closed position, to seal the sealing strip assembly directly against both the magnet and the floor.

When used at a top edge of a door, the door edge assembly may not require the elastic element in order to function, as gravity may be sufficient to effect retraction of the sealing strip.

According to a further aspect then, there is provided an automatic door top seal assembly for a door which is movable between open and closed positions with respect to a doorway, the automatic door bottom seal assembly comprising at least one magnet for securing with respect to the doorway, a door top assembly for mounting with respect to a top edge of the door, the door top assembly comprising a base, the base comprising a channel in which a sealing strip assembly is seated, and with respect to which the sealing strip assembly can move between its extended and retracted position relative to the base, wherein in use, gravity may bias the sealing strip assembly toward the retracted position and clear of the doorway, and the magnet may overcome the bias of gravity to draw the sealing strip assembly into the extended position as the door reaches its closed position, to seal the sealing strip assembly directly against both the magnet and the doorway.

According to a further aspect, there is provided a door top assembly for use with at least one magnet secured with respect to a doorway, the door top assembly comprising a base, the base comprising a channel in which a sealing strip assembly is seated, and with respect to which the sealing strip assembly can move between its extended and retracted position relative to the base, wherein in use, gravity may bias the sealing strip assembly toward the retracted position and clear of the doorway, and the magnet may overcome the bias of gravity to draw the sealing strip assembly into the extended position as the door reaches its closed position, to seal the sealing strip assembly directly against both the magnet and the doorway.

It will be apparent then, that all of the automatic door seal assemblies described above do not comprise a threshold plate.

In one form, in an alternative, any one of the above described arrangements could be reversed, so that the ferromagnetic part is securable to the floor and the or each magnet depends from the door edge assembly.

According to a further aspect, there is provided an automatic door bottom seal assembly for a door which is movable between open and closed positions with respect to a doorway, the automatic door bottom seal assembly comprising at least one ferromagnetic part for securing with respect to a floor area within the doorway, a door bottom assembly for mounting with respect to a bottom edge of the door, the door bottom assembly comprising a base, at least one elastic element depending from the base, at least one sealing strip assembly comprising at least one magnet and depending from the elastic element so as to be movable between a retracted position and an extended position relative to the base, wherein in use, the elastic element may bias the sealing strip assembly toward the retracted position and clear of the floor, and the magnet may overcome the bias of the elastic element to draw the sealing strip assembly into the extended position as the door reaches its closed position, to seal the sealing strip assembly directly against both the ferromagnetic part and the floor.

In one form, the or each ferromagnetic part is secured to the floor in such a way as to project from the floor. In this case, it is preferable that the ferromagnetic part is positioned at or near an edge of the doorway.

In one form, the automatic door bottom seal assembly comprises two ferromagnetic parts. Where these ferromagnetic parts project from the floor, it is preferable that each ferromagnetic part is positioned at or near an opposing edge of the doorway.

In one form, the or each ferromagnetic part is secured to the floor in such a way as to be substantially flush therewith.

In one form, in an alternative, the automatic door bottom seal assembly comprises a threshold plate.

In one form, the threshold plate comprises the or each magnet.

In one form, the threshold plate comprises a plurality of magnets spaced apart therealong.

In one form, the or each magnet is flush with the threshold plate.

In one form, any one of the above described sealing strip assemblies may comprise a strip of intumescent material extending therealong.

### DESCRIPTION OF THE DRAWINGS

The foregoing aspects and many of the attendant advantages of the present disclosure will become more readily appreciated as the same become better understood by reference to the following detailed description, when taken in conjunction with the accompanying drawings, wherein:

FIG. 1 illustrates one representative embodiment of a door in a closed position, where the door is equipped with an automatic door seal assembly in accordance with an aspect of the present disclosure;

FIG. 2 is an isometric view of a portion of the automatic door seal assembly of FIG. 1;

FIG. 3 is an end view of the automatic door seal assembly of FIG. 1;

FIGS. 4-6 illustrate the door of FIG. 1 in a first, partially open position;

FIG. 7 is an isometric view of a portion of the automatic door seal assembly of the partially open door of FIGS. 4-6;

FIG. 8 illustrates the door of FIG. 1 in a second, further open position;

FIG. 9 is an isometric view of a portion of the automatic door seal assembly of the further open door of FIG. 8;

FIGS. 10 and 11 illustrate another representative embodiment of a door in an open position, where the door is equipped with an automatic door seal assembly at both a top edge and a bottom edge thereof in accordance with an aspect of the present disclosure;

FIG. 12 illustrates the door of FIG. 10 in a partially open position; and

FIG. 13 illustrates the door of FIG. 10 is a fully closed position.

### DETAILED DESCRIPTION

The detailed description set forth below in connection with the appended drawings, where like numerals reference like elements, are intended as a description of various embodiments of the present disclosure and are not intended to represent the only embodiments. Each embodiment described in this disclosure is provided merely as an example or illustration and should not be construed as precluding other embodiments. The illustrative examples provided herein are not intended to be exhaustive or to limit the disclosure to the precise forms disclosed.

In the following description, specific details are set forth to provide a thorough understanding of exemplary embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

For ease of description, an automatic door bottom seal assembly is described below in its usual assembled position as shown in the accompanying drawings, and terms such as front, rear, upper, lower, horizontal, longitudinal etc., may be used with reference to this usual position. However, the automatic door bottom seal assembly may be manufactured, transported, sold, or used in orientations other than that described and shown here. These references, and other similar references in the present application, are only to assist in helping describe and to understand the particular embodiment and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, lists of two or more elements of the form, for example, “at least one of A, B, and C,” is intended to mean (A), (B), (C), (A and B), (A and C), (B and C), or (A, B, and C), and further includes all similar permutations when any other quantity of elements is listed.

The following description provides several examples that relate to an automatic door seal. While reference is made to door bottom seals for the purpose of explanation, the present disclosure is not limited to use at a bottom edge of a door, and may be employed at a top edge or a side edge of a door.

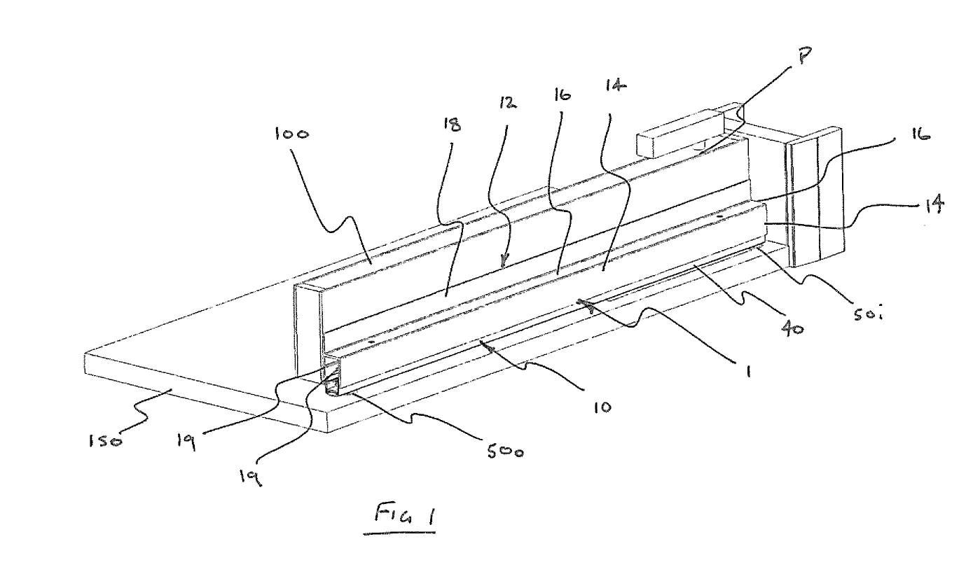

Referring now to FIG. 1, where there is illustrated a door 100 comprising an automatic door seal assembly 1.

The illustrated embodiment of the door 100 is a pivot door, and so it is mounted on pivots P along its top and bottom edges (as opposed to a hinge along a side edge); however, embodiments of the present disclosure are not limited to doors of this type.

The automatic door bottom seal assembly 1 comprises a door edge assembly 10 mounted along a bottom edge of the door 100, and further comprises a pair of magnets 50 in this embodiment, each of which is secured to the floor 150 within a doorway for the door 100, at a position toward an edge (i.e. at or near either side) of the doorway. A first magnet 50i is located nearest to the pivot P (hereinafter ‘inner magnet 50i’), and a second magnet 50o is located further from the pivot P (hereinafter ‘outer magnet 50o’). From these positions, the magnets 50 can cooperate with the door bottom assembly 10 without posing a tripping hazard.

In this embodiment, each of the magnets 50 comprise a disc shape, and they are secured to the ground using a suitable means, such as, but not limited to, a fastener and/or an adhesive.

The door edge assembly 10 comprises a base 12, which comprises an elongate body of substantially constant cross-sectional shape throughout its length. The body comprises a pair of parallel flanges 14 bridged by an end strip 16 so as to define a generally U-shaped channel 12c, which in use, will be downwardly facing. The body further comprises an attachment flange 18 extending from the end strip 16 in a direction opposite to the parallel flanges 14. In use, the door edge assembly 10 is secured with respect to the door 100 via the attachment flange 18.

A lengthwise extending lip 19 projects into the channel from each of the parallel flanges 14, in an opposing fashion. A pair of upper retaining blocks 22 is captured in the channel 12c by (above in this case) these lips 19, in a spaced apart relationship. An elastic element 20 in the form of an elongate leaf spring extends between, and so depends from, these upper retaining blocks 22, and the base 12 in turn.

A sealing strip assembly 30 depends from the elastic element 20. The sealing strip assembly 30 comprises a rail 32, a strip 33 of ferromagnetic material, e.g., steel, extending along a lower edge of the rail 32, and a sealing strip 40 of an elastomeric material disposed over, and extending along, the rail 32 and strip 33. This sealing strip assembly 30 nests in the downwardly facing channel defined by the base 12.

The rail 32 comprises an elongate body of substantially constant cross-sectional shape throughout its length. The rail 32 comprises a pair of parallel flanges 34 bridged by web 36 so as to define a generally U-shaped channel 32c, which in use for some embodiments, will be upwardly facing.

A lengthwise extending lip 38 projects into the channel 32c from the each of the parallel flanges 34, in an opposing fashion. A lower retaining block 23 for the elastic element 20 is captured by (below in this case) these lips 38, and so the sealing strip assembly 30 depends from the resilient element 20.

Beneath the web 36 the rail 32 comprises a further pair of inwardly directed (and so opposing) lengthwise extending lips 39 for retaining the steel strip 33.

A distinct strip 33 may not be necessary if another part of the door edge assembly 10, such as the rail 32, is made of or incorporates a ferromagnetic material. However, where the other parts of the door bottom assembly 10 are, for reasons such as lightness or economy of manufacture, made of paramagnetic materials such as aluminum, or diamagnetic materials wood and some plastics, a distinct strip 33 will be required.

The sealing strip 40 comprises an elongate body of substantially constant, U-shaped cross-sectional shape throughout its length. The sealing strip 40 further comprises a pair of edges, and a bead 42 extending along each edge.

Each of the parallel flanges 34 of the rail 32 terminates at either side of the upwardly facing channel in an outwardly curled edge 44 defining a channel 44c which is sized and shaped to both receive and retain one of the edge beads 42 of the sealing strip 40.

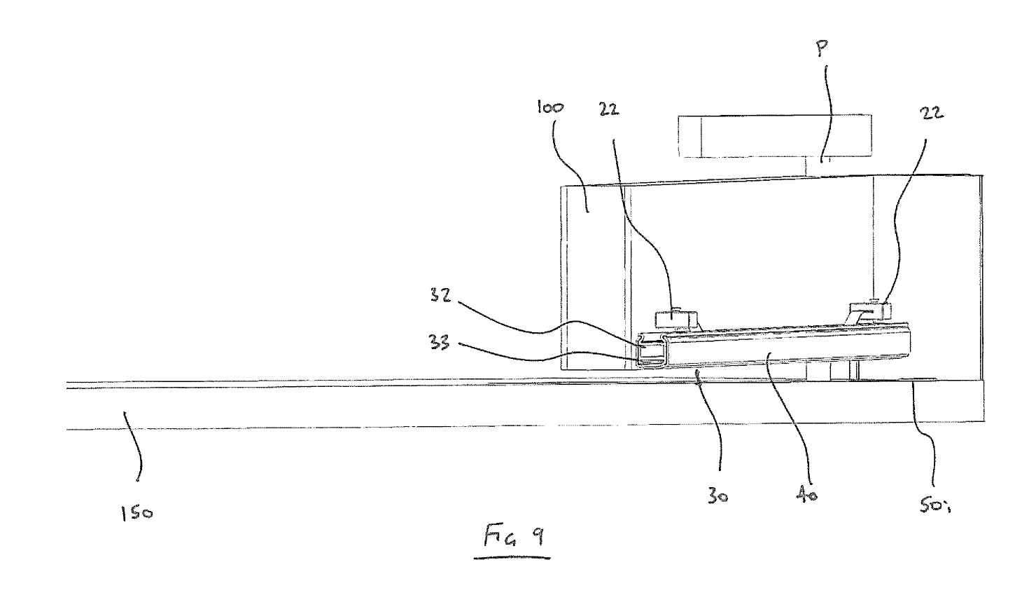

In use, when the door 100 is in an open position, as illustrated in FIG. 9, the elastic element 20 biases the sealing strip assembly 30 toward a retracted position within the channel 12c defined by the base 12, and clear of the floor 150.

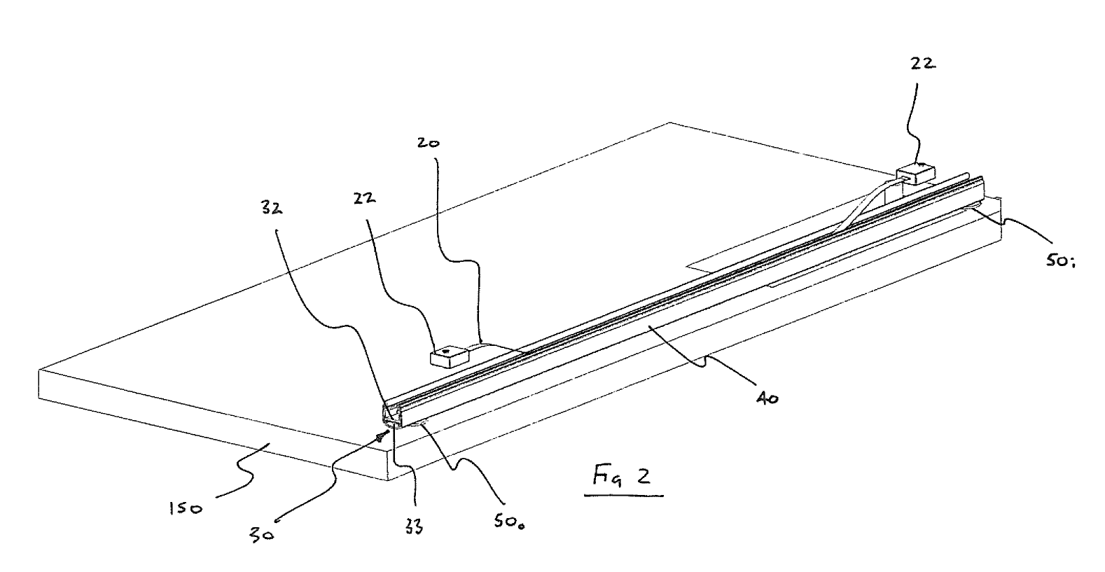

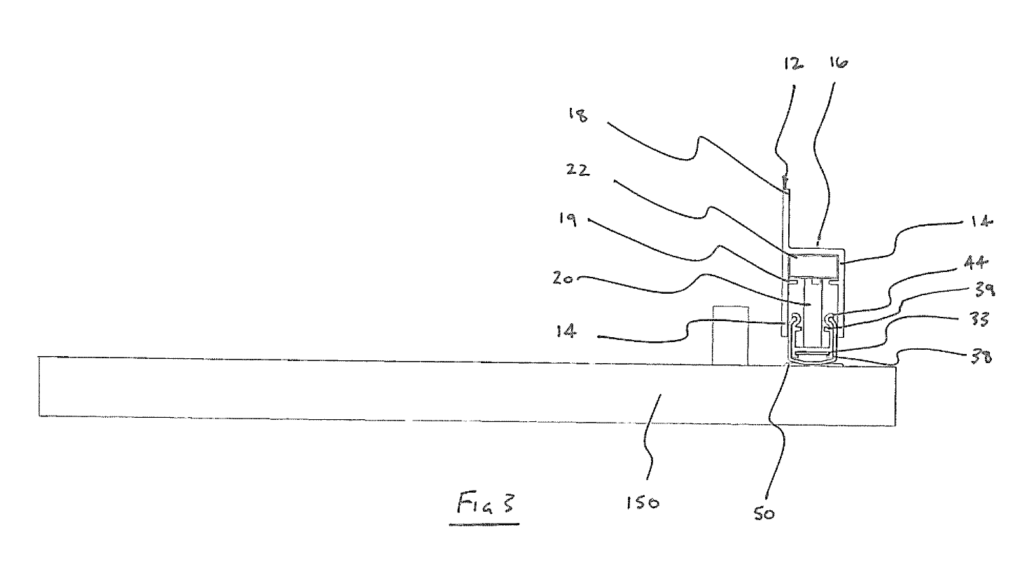

When the door 100 reaches a closed position, as illustrated in FIGS. 1, 2, and 3, the magnets 50 overcome the bias of the elastic element 20 to draw the sealing strip assembly 30 into an extended position to seal the sealing strip assembly 30 directly against both the magnets 50 and the floor 150.

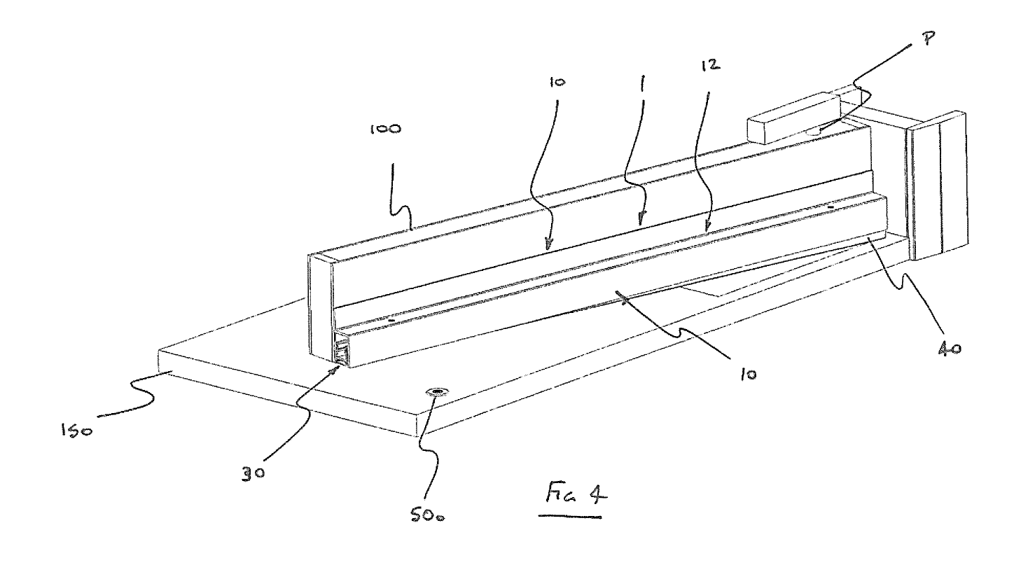

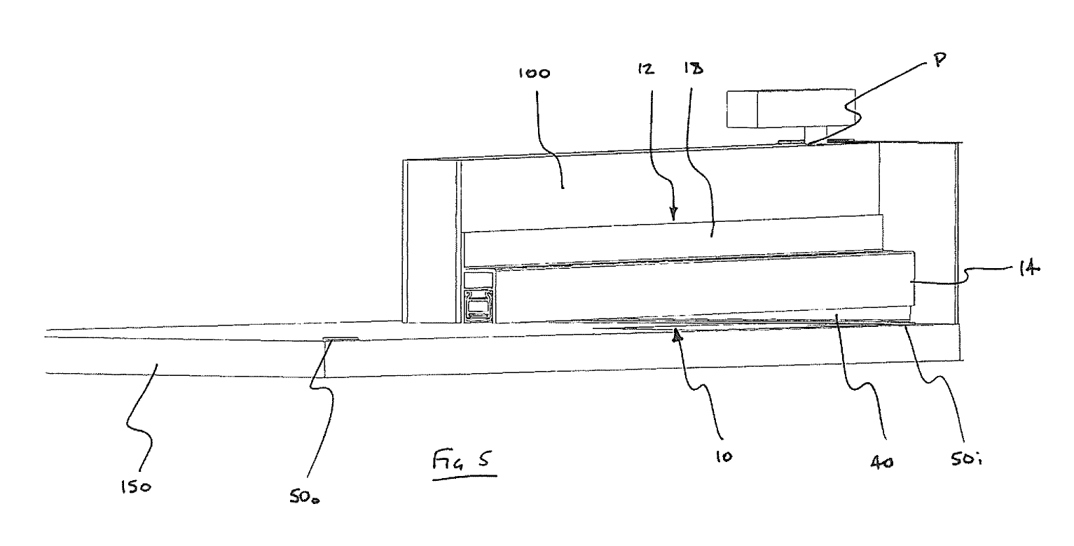

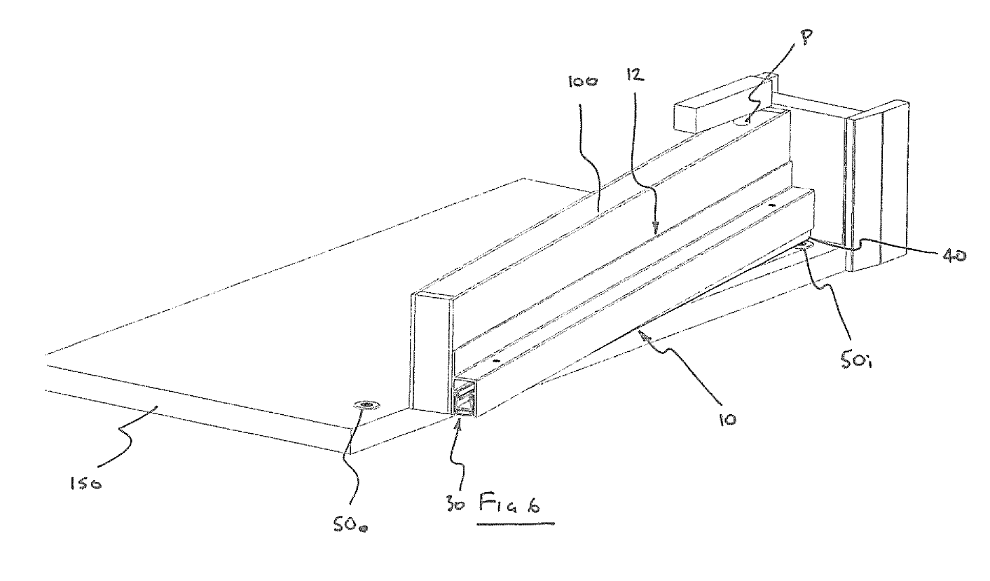

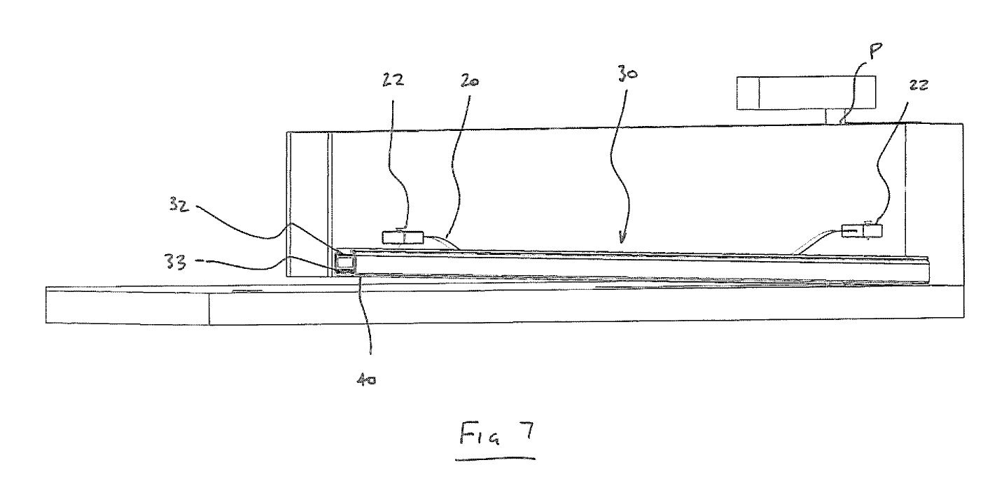

When the door 100 approaches the closed position, as illustrated in FIGS. 4 through 7, an inner portion (relative to the door pivot) of the sealing strip assembly 30 will fall under the influence of the magnet 50i nearest to the door pivot, before an outer portion (again relative to the door pivot) of the sealing strip assembly 30 will fall under the influence of the magnet 50o furthest from the door pivot P. The result of this is that the inner portion of the sealing strip assembly 30 will seal against the inner magnet 50i and the floor 150, while the outer portion of the sealing strip 40 will remain clear of the floor 150 as the door 100 completes its travel. As the door 100 reaches the closed position, the outer portion of the sealing strip assembly 30 will fall under the influence of the magnet 50 furthest from the door pivot P and seal against the outer magnet 50 and the floor 150.

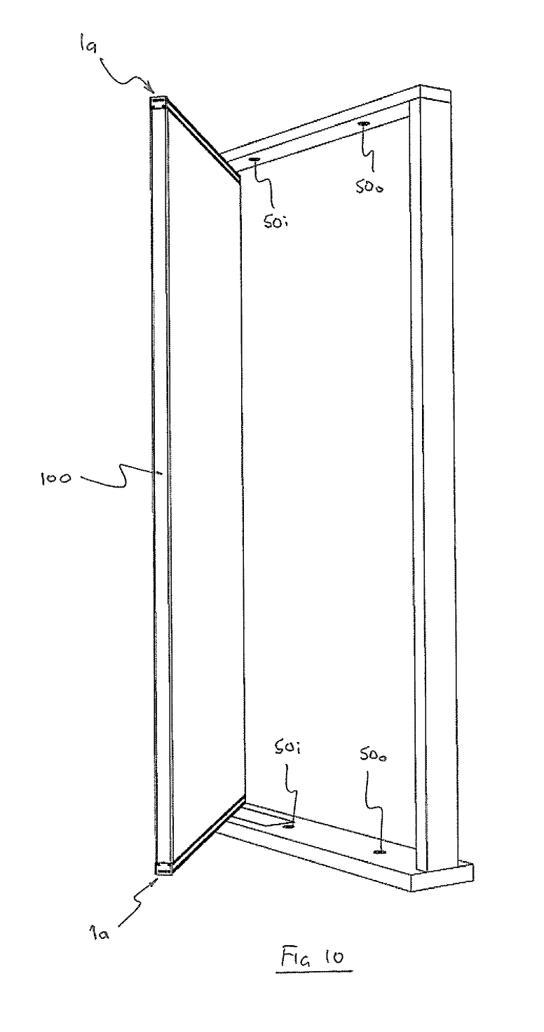

Referring now to FIGS. 10 through 13, where there is illustrated a door 100 comprising an automatic door seal assembly 1a at both a top edge and a bottom edge thereof.

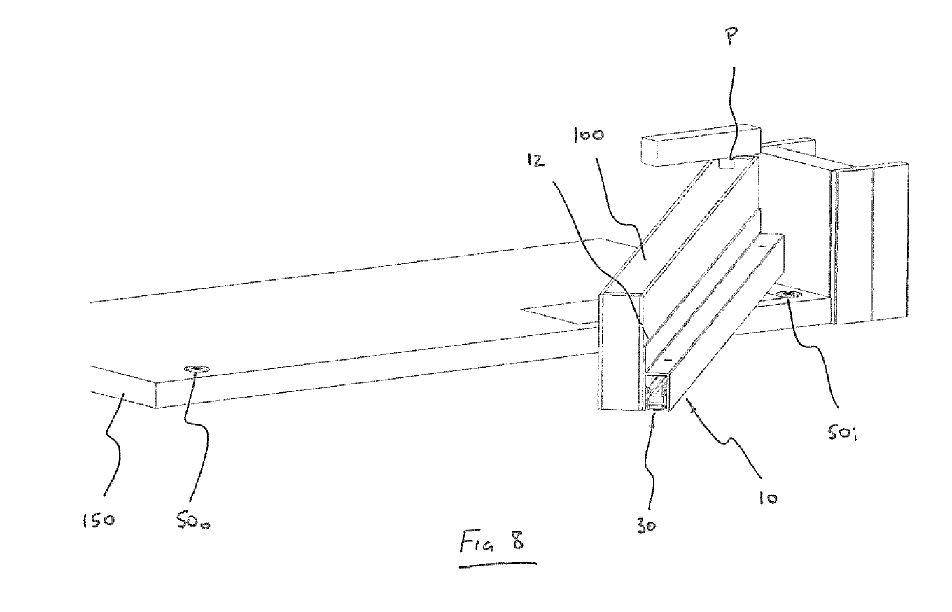

Those parts of the automatic door seal assemblies 1a which are identical (or near-identical) to corresponding parts shown in the automatic door seal assembly 1 of FIGS. 1 through 9, will be denoted by the same reference numerals and will not be described again in detail.

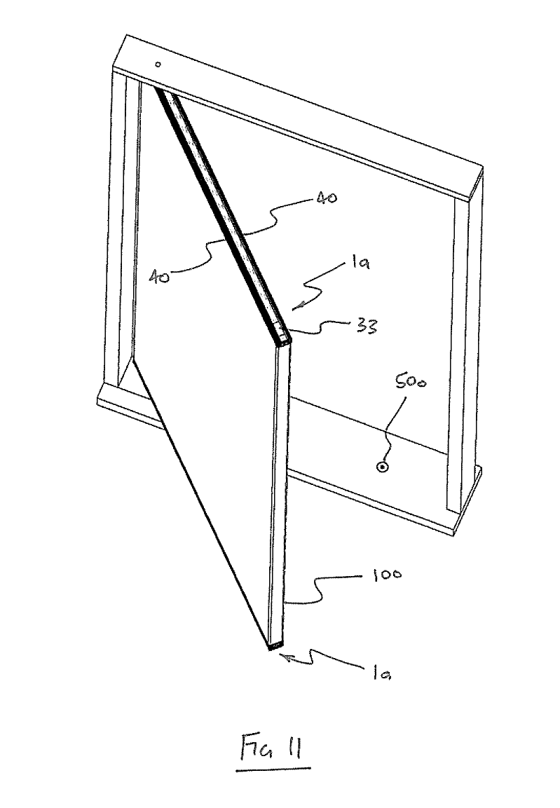

With reference to FIG. 11, it can be seen that automatic door seal assembly 1a comprises a pair of sealing strips 40, and tabs 33 of ferromagnetic material (steel in this case) located between the sealing strips 40. A strip of intumescent material may also be run between the sealing strips 40 and tabs 33

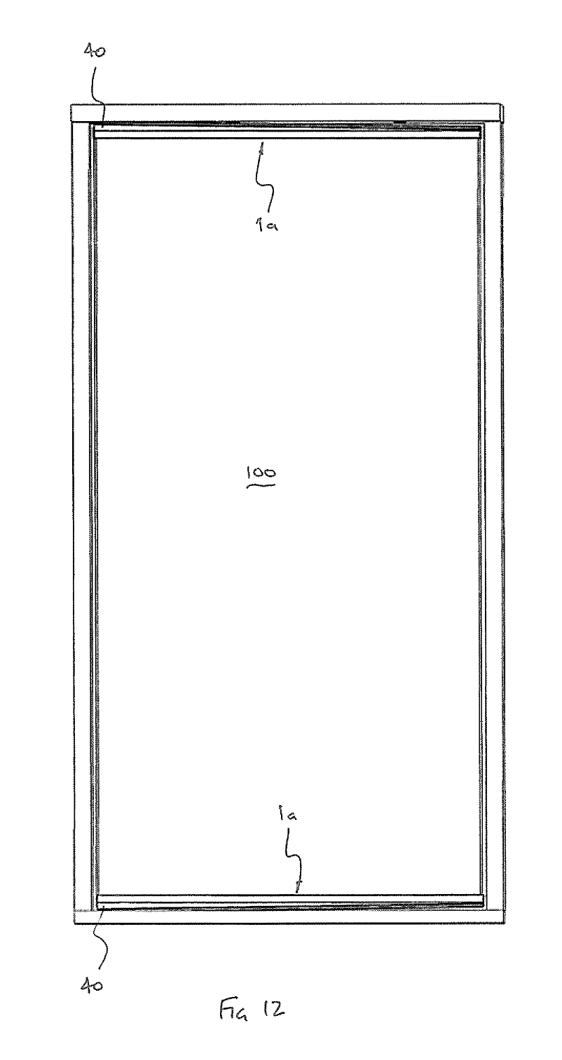

When the door 100 approaches the closed position, as illustrated in FIG. 12, an inner portion (relative to the door pivot) of each (i.e. door top and bottom) sealing strip assembly 30 will fall under the influence of the magnet 50i nearest to the door pivot, before an outer portion (again relative to the door pivot) of each sealing strip assembly 30 will fall under the influence of the magnet 50o furthest from the door pivot P. The result of this is that the inner portion of each sealing strip assembly 30 will seal, while the outer portion of each sealing strip 40 will remain clear as the door 100 completes its travel.

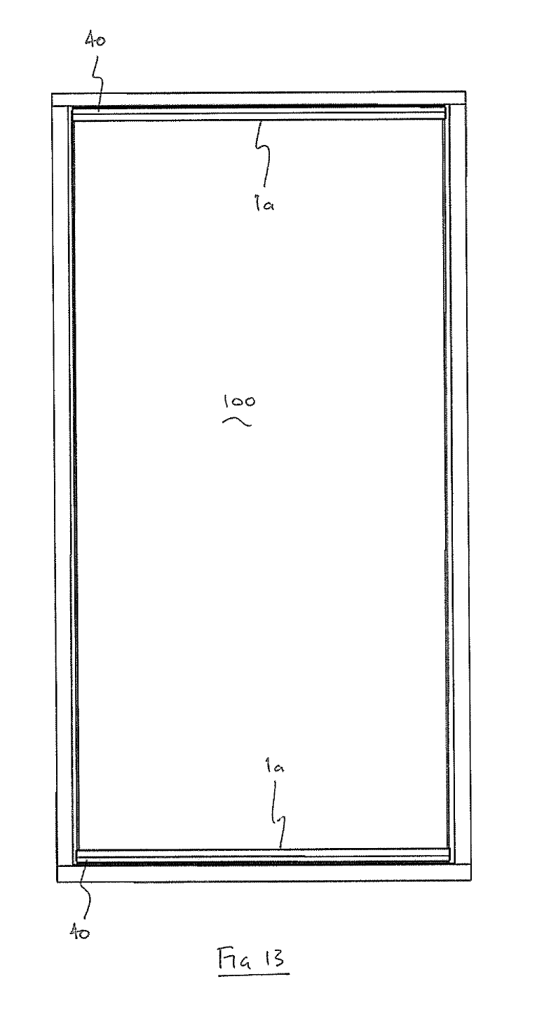

As the door 100 reaches the closed position, as illustrated in FIG. 13, the outer portion of the sealing strip assembly 30 will fall under the influence of the magnet 50 furthest from the door pivot P and seal against the outer magnet 50 and the floor 150.

In embodiments, the automatic door seal assembly described herein does not require a threshold plate to operate or seal. The omission of the threshold plate eliminates a potential tripping hazard in the threshold plate, and, in the opinion of many, results in an improved aesthetic.

The door seal assembly described herein automatically adjusts to the gap under the door. Typical automatic threshold seals have an actuation mechanism, and this mechanism requires an adjustment method to set the travel of the mechanism to cater for different size gaps under the door.

The door seal assembly described herein comprises fewer operating parts than typical automatic threshold seals. Particularly ones that have very little end float. Naturally this provides an economic benefit to cost and reliability of producing the door seal assembly.

The seal carrier door of the seal assembly described herein only comes down when completely over the magnet. Non-magnetic seals all have some degree of wear due to the seal dragging. Fine adjustment is required to achieve a seal with minimal wear. There is no requirement for this on the seal assembly described herein.

The door seal assembly described herein can be used on all types of hinged doors without any special accessory or modification. It is suitable for door types including, but not necessarily limited to, butt hinged, pivot hung, parliament hinged, and sliding doors. This is not the case with other methods of automatic threshold seals.

There is a benefit to using the door seal assembly described herein with frame-less glass doors, especially where they are pivot hung. The practicality of door hardware interfering with actuation push rods of other types of automatic threshold seals means these types of seals cannot be used.

The door seal assembly described herein can be used on single acting and double acting doors.

A maximum closing sealing force of the door seal assembly described herein is achieved at all suitable gaps as the magnetic attraction is at its maximum when the steel plate is closest to the magnet. This ensures a positive seal that is maintained.

For the door seal assembly described herein, very little door closing and opening forces are required whilst still maintaining a heavy duty threshold seal. Other heavy duty mechanisms usually require heavy tension springs resulting in high door closing forces. This is not desirable in health care and disabled access/egress buildings.

The magnet/steel plate combination of the door seal assembly described herein requires less break away force than two strip magnets and provide a cleaner more immediate break away of the seal which reduces dragging of the sealing gasket.

For the door seal assembly described herein, there is no latching required to hold the seal in place when the door is closed.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

The embodiments of the invention in which an exclusive property or privilege is claimed are defined as follows:

1. An automatic door seal assembly for a door movable between an open position and a closed position with respect to a doorway, the automatic door seal assembly comprising:
a magnet secured to a surface of the doorway adjacent to an edge of the door in the closed position; and
a door edge assembly configured to mount to the edge of the door, the door edge assembly comprising:
a base;
an elastic element coupled to the base; and
a sealing strip assembly comprising a ferromagnetic part and depending from the elastic element, such that the sealing strip assembly is configured to be movable between a retracted position and an extended position relative to the base,
wherein the elastic element biases the sealing strip assembly toward the retracted position to clear of the surface, and wherein, as the door approaches the closed position, the magnet overcomes the bias of the elastic element to transition the sealing strip assembly into the extended position to contact the surface.

2. The automatic door seal assembly of claim 1, wherein the magnet is secured to the surface in such a way as to be substantially flush therewith.

3. The automatic door seal assembly of claim 1, wherein the magnet is secured to the surface in such a way as to at least partially project from the surface.

4. The automatic door seal assembly of claim 1, wherein the surface is the floor within the doorway.

5. The automatic door seal assembly as in claim 1, wherein the automatic door seal assembly comprises at least two magnets.

6. The automatic door seal assembly of claim 5, wherein each magnet is positioned on different surfaces.

7. The automatic door seal assembly of claim 1, wherein the magnet is a rare earth magnet.

8. The automatic door seal assembly of claim 1, wherein the sealing strip assembly directly seals against the magnet as the door reaches its closed position.

9. The automatic door seal assembly of claim 1, wherein the base comprises a channel in which the sealing strip assembly is seated and is configured to move between the extended and retracted positions.

10. The automatic door seal assembly of claim 1, wherein the elastic element comprises a leaf spring.

11. The automatic door seal assembly of claim 1, wherein the sealing strip assembly comprises an elongate body, and an elongate gasket disposed over the body.

12. The automatic door seal assembly of claim 11, wherein the ferromagnetic part depends from the body and is positioned behind the gasket.

13. The automatic door seal assembly of claim 1, wherein the ferromagnetic part comprises a flat strip.

14. The automatic door seal assembly of claim 1, wherein the ferromagnetic part is metal.

15. A door edge assembly for use with a magnet secured with respect to a surface of a doorway, the door edge assembly comprising:
a base for mounting to an edge of a door;
an elastic element associated with the base; and
a sealing strip assembly comprising a ferromagnetic part and depending from the elastic element, such that the sealing strip assembly is configured to be movable between a retracted position and an extended position relative to the base,
wherein the elastic element biases the sealing strip assembly toward the retracted position and clear of the surface, and wherein, as the door approaches the closed position, the magnet overcomes the bias of the elastic element to transition the sealing strip assembly into the extended position to contact the surface.

16. An automatic door top seal assembly for a door movable between open and closed positions with respect to a doorway, the automatic door top seal assembly comprising:
a magnet secured to an upper surface within the doorway; and
a door top assembly configured to mount to a top edge of the door, the door top assembly comprising a base having a channel in which a sealing strip assembly is seated, the sealing strip assembly configured to move between an extended position and a retracted position relative to the base,
wherein gravity biases the sealing strip assembly toward the retracted position to clear the upper surface, and wherein, as a door mounted in the doorway approaches a closed position, the magnet overcomes the bias of gravity to transition the sealing strip assembly to the extended position to contact one or more of the upper surface and the magnet.

17. A door bottom assembly for use with a magnet secured to a floor surface within a doorway, the door bottom assembly comprising:
a base for mounting to a bottom edge of the door;
an elastic element coupled to the base; and
a sealing strip assembly comprising a ferromagnetic part and depending from the elastic element, such that the sealing strip assembly is movable between a retracted position and an extended position relative to the base,
wherein the elastic element biases the sealing strip assembly toward the retracted position to clear the floor surface, and wherein, as a door mounted in the doorway approaches a closed position, the magnet overcomes the bias of the elastic element to transition the sealing strip assembly to the extended position to contact one or more of the floor surface and the magnet.

18. The door bottom seal assembly of claim 17, further comprising a threshold plate containing the magnet.

19. The door bottom seal assembly of claim 18, wherein the threshold plate comprises a plurality of magnets in a spaced apart configuration along the threshold plate.

20. The door bottom seal assembly of claim 18, wherein the magnet is flush with the threshold plate.
